(19) United States
(12) Patent Application Publication
(10) Pub. No.: US 2004/0140893 A1
(43) Pub. Date: Jul. 22, 2004

(54) Combination telephone, wireless activator, and sign apparatus

(76) Inventor: Helen S. Carter, Acworth, GA (US)

Correspondence Address: S. Michael Bender, P.O. Box 530399, St. Petersburg, FL, 33747, US

(21) Appl. No.: 10/345,801

(22) Filed: Jan. 16, 2003

(51) Int. Cl. G08B 1/08

(52) U.S. Cl. 340/539.1; 340/573.1; 379/37

(57) ABSTRACT

A combination telephone, wireless activator, and sign apparatus includes a telephone which includes telephone-attached connecting means. An activation button unit includes button-unit-attached connecting means, and the button-unit-attached connecting means are physically attached to the telephone-attached connecting means, whereby the activation button unit is physically attached to the telephone. The activation button unit includes an activation-unit transmitter, an activation-unit battery power source, and an activation-unit switch for connecting battery power from the activation-unit battery power source to the activation-unit transmitter. A remotely-located illuminated sign unit includes a sign receiver/sign actuator unit, a sign battery power source, and an illuminated display unit which is powered by the sign battery power source. The apparatus of the invention can alert emergency service workers to the location of a “911” call with the illuminated display unit.

### BACKGROUND OF THE INVENTION

1. Field of the Invention

The present invention relates generally to telephones and signs, and, more particularly, to a telephone especially adapted for activating a sign remote from the telephone.

2. Description of the Prior Art

Signs that are activated through a wireless link are known in the art. More specifically, a number of signs that are activated through a wireless link display pertinent information outside of a building which can enable emergency service workers to rapidly locate a building where an emergency situation is occurring. For example, the following U.S. patents disclose signs that are activated through a wireless link and display pertinent information outside of a building which can enable emergency service workers to rapidly locate a building where an emergency situation is occurring: U.S. Pat. Nos. 3,911,425, 5,587,704, and 6,252,509. With respect to these three patents, a variety of locations are provided for an activation button unit for activating the sign activated through a wireless link. Yet, there is no disclosure of providing an activation button unit in combination with a telephone. When an emergency situation is perceived by a person, a telephone is often employed for summoning aid. Rather than having the telephone at one location and an activation button unit at another location, for convenience, it would be desirable if the activation button unit for a remotely-located sign were combined with a telephone.

As a matter of interest, U.S. Pat. No. 3,913,092 discloses a window-mounted, emergency-location identification sign that includes an activation button mounted directly on the housing of the sign. As stated above, it would be desirable if the activation button unit for a remotely-located sign were combined with a telephone.

Also as a matter of interest, U.S. Pat. No. 4,730,184 disclosed a sign that is hard wired to a remotely-located sign. A sign that is activated through a wireless link has a major advantage over a hard-wired connection between a sign and an activation button unit. The respective locations of the activation button unit and the sign that is activated through a wireless link can be easily changed relative to one another without being concerned about routing or re-routing wiring.

Still other features would be desirable in a combination telephone, wireless activator, and sign apparatus. For example, a conventional telephone is not combined with an activation button unit for activating a remotely-located sign. In this respect, it would be desirable to retrofit a conventional telephone so that it is combined with an activation button unit for activating a remotely-located sign.

After an activation button unit is combined with a telephone, there may a later time when it would be desirable to remove the activation button unit from the telephone and place it in combination with another telephone. In this respect, it would be desirable if the physical connection between the activation button unit and the telephone can be easily disconnected so that the activation button unit can be easily connected to another telephone.

For convenience, it would be desirable if both the activation button unit and the remotely-located sign had their own respective electrical power supplies. That is, it would be desirable if the both the activation button unit and the remotely-located sign had their own respective batteries.

Aside from retrofitting a conventional telephone with an activation button unit, it would be desirable if an originally manufactured telephone included an activation button unit for activating a remotely-located sign.

Thus, while the foregoing body of prior art indicates it to be well known to use an activation button unit to activate a remotely-located sign, the prior art described above does not teach or suggest a combination telephone, wireless activator, and sign apparatus which has the following combination of desirable features: (1) a combination of an activation button unit for a remotely-located sign and a telephone; (2) provides for retrofitting a conventional telephone so that it is combined with an activation button unit for activating a remotely-located sign; (3) provides a physical connection between the activation button unit and the telephone which can be easily disconnected so that the activation button unit can be easily connected to another telephone; (4) provides both the activation button unit and the remotely-located sign with their own respective batteries; and (5) can also provide an originally manufactured telephone which includes an activation button unit for activating a remotely-located sign. The foregoing desired characteristics are provided by the unique combination telephone, wireless activator, and sign apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a combination telephone, wireless activator, and sign apparatus which includes a telephone which includes telephone-attached connecting means. An activation button unit includes button-unit-attached connecting means, and the button-unit-attached connecting means are physically attached to the telephone-attached connecting means, whereby the activation button unit is physically attached to the telephone. The activation button unit includes an activation-unit transmitter, an activation-unit battery power source, and an activation-unit switch for connecting battery power from the activation-unit battery power source to the activation-unit transmitter. A remotely-located illuminated sign unit includes a sign receiver/sign actuator unit, a sign battery power source, and an illuminated display unit which is powered by the sign battery power source when the illuminated display unit is electrically connected to the sign battery power source by the sign receiver/sign actuator unit. The apparatus of the invention can alert emergency service workers to the location of a “911” call with the illuminated display unit.

Preferably, the activation-unit switch is a push-button switch. Also, preferably, the activation button unit and the remotely-located illuminated sign unit include indicia indicating the emergency code “911”.

The telephone-attached connecting means and the button-unit-attached connecting means can be a quantity of adhesive material located between the activation button unit and the remotely-located illuminated sign unit.

The telephone-attached connecting means include a quantity of first hook or loop material, and the button-unit-attached connecting means include a quantity of second hook or loop material. The first hook or loop material and the second hook or loop material are complimentary and interconnectable.

The telephone and the activation button unit can be combined as a unified, integrated, originally manufactured combination telephone.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved combination telephone, wireless activator, and sign apparatus which has all of the advantages of the prior art and none of the disadvantages.

It is another object of the present invention to provide a new and improved combination telephone, wireless activator, and sign apparatus which may be easily and efficiently manufactured and marketed.

It is a further object of the present invention to provide a new and improved combination telephone, wireless activator, and sign apparatus which is of durable and reliable construction.

An even further object of the present invention is to provide a new and improved combination telephone, wireless activator, and sign apparatus which is susceptible of a low cost of manufacture with regard to both materials and labor, and which accordingly is then susceptible of low prices of sale to the consuming public, thereby making such combination telephone, wireless activator, and sign apparatus available to the buying public.

Still yet a further object of the present invention is to provide a new and improved combination telephone, wireless activator, and sign apparatus which a combination of an activation button unit for a remotely-located sign and a telephone.

Still another object of the present invention is to provide a new and improved combination telephone, wireless activator, and sign apparatus that provides for retrofitting a conventional telephone so that it is combined with an activation button unit for activating a remotely-located sign.

Yet another object of the present invention is to provide a new and improved combination telephone, wireless activator, and sign apparatus which provides a physical connection between the activation button unit and the telephone which can be easily disconnected so that the activation button unit can be easily connected to another telephone.

Even another object of the present invention is to provide a new and improved combination telephone, wireless activator, and sign apparatus that provides both the activation button unit and the remotely-located sign with their own respective batteries.

Still a further object of the present invention is to provide a new and improved combination telephone, wireless activator, and sign apparatus which can also provide an originally manufactured telephone which includes an activation button unit for activating a remotely-located sign.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view showing a first embodiment of the combination telephone, wireless activator, and sign apparatus of the invention, wherein the activation button unit is retrofitted to a conventional telephone.

FIG. 2 is an enlarged, top view of the embodiment of the combination telephone, wireless activator, and sign apparatus shown in FIG. 1 taken along line 2-2 of FIG. 1, wherein the activation button unit is physically attached to the telephone using a quantity of adhesive material between the telephone and the activation button unit.

FIG. 3 is an exploded top view of a second embodiment of the invention, wherein the activation button unit is physically detached from the telephone, wherein the telephone includes a quantity of first hook or loop material, and wherein the activation button unit includes a quantity of second hook or loop material.

FIG. 4 is an enlarged front view of the remotely-located sign of FIG. 1, which displays “911”, taken along line 4-4 of FIG. 1.

FIG. 5 is a front view of a third embodiment of the invention wherein an originally manufactured telephone includes an activation button unit for activating a remotely-located sign that displays “911”.

### DESCRIPTION OF THE PREFERRED EMBODIMENT

With reference to the drawings, a new and improved combination telephone, wireless activator, and sign apparatus embodying the principles and concepts of the present invention will be described.

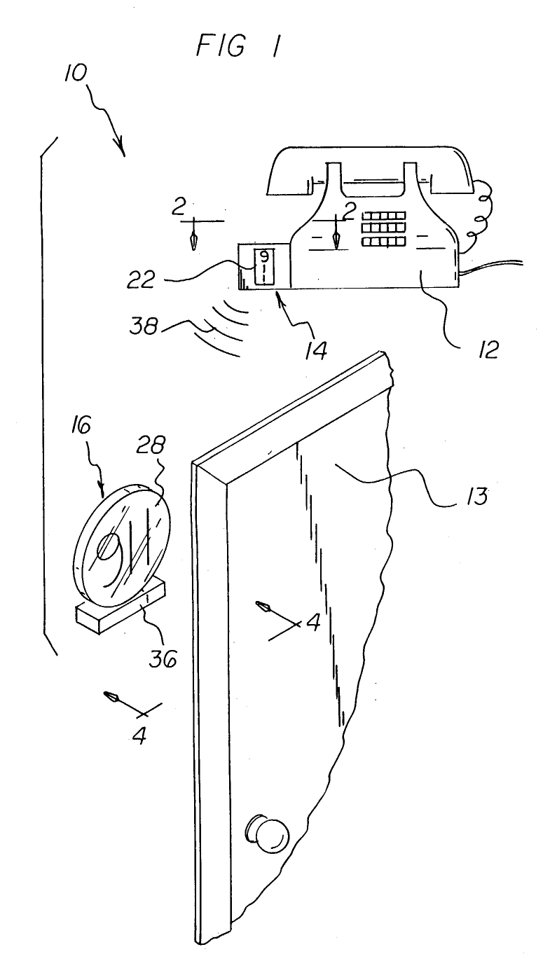

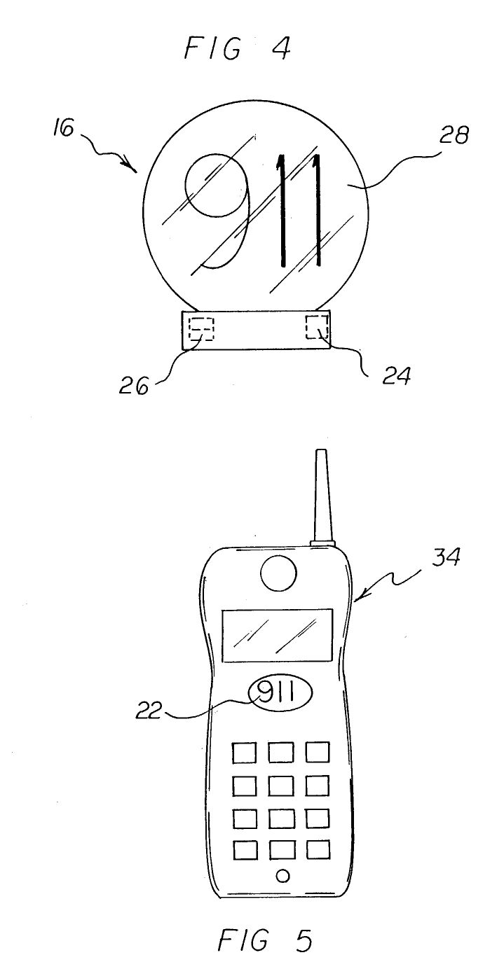

Turning to FIGS. 1, 2, and 4, there is shown a first embodiment of the combination telephone, wireless activator, and sign apparatus of the invention generally designated by reference numeral 10. In the first embodiment, combination telephone, wireless activator, and sign apparatus 10 includes a telephone 12 which includes telephone-attached connecting means. An activation button unit 14 includes button-unit-attached connecting means. The button-unit-attached connecting means are physically attached to the telephone-attached connecting means, whereby the activation button unit 14 is physically attached to the telephone 12. The activation button unit 14 includes an activation-unit transmitter 18, an activation-unit battery power source 20, and an activation-unit switch 22 for connecting battery power from the activation-unit battery power source 20 to the activation-unit transmitter 18. A remotely-located illuminated sign unit 16 includes a sign receiver/sign actuator unit 24, a sign battery power source 26, and a display unit 28 which is powered by the sign battery power source 26 when the display unit 28 is electrically connected to the sign battery power source 26 by the sign receiver/sign actuator unit 24.

Preferably, the activation-unit switch 22 is a push-button switch 22. Also, preferably, the activation button unit 14 and the remotely-located illuminated sign unit 16 include indicia indicating the emergency code “911”.

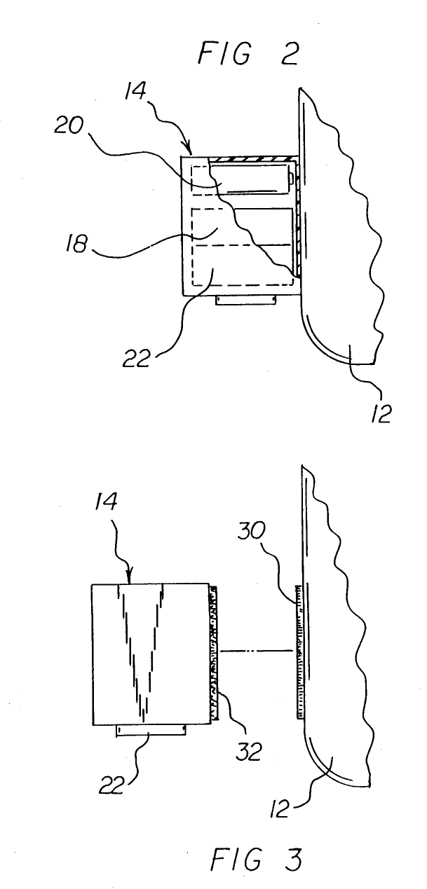

The telephone-attached connecting means and the button-unit-attached connecting means can be a quantity of adhesive material located between the activation button unit 14 and the remotely-located illuminated sign unit 16 as shown in FIG. 2.

With the embodiment of the invention shown in FIG. 3, the telephone-attached connecting means include a quantity of first hook or loop material 30, and the button-unit-attached connecting means include a quantity of second hook or loop material 32. The first hook or loop material 30 and the second hook or loop material 32 are complimentary and interconnectable. The first hook or loop material 30 and the second hook or loop material 32 can be made from well known VELCRO(TM) material.

As shown in FIG. 5, the telephone and the activation button unit can be combined as a unified, integrated, originally manufactured combination telephone 34.

As shown in FIG. 1, the remotely-located illuminated sign unit 16 can be fixed to a wall 36 adjacent to a door 13 so as to alert emergency service workers as to the desired location who respond to a “911” call. Alternatively, the sign unit 16 may be placed in the window of a house such that it is clearly visible from the street exterior to the house, or it may even be suitably affixed on the outside portion of the house.

To use the combination telephone, wireless activator, and sign apparatus 10 or the unified, integrated, originally manufactured combination telephone 34. When a person fears an emergency situation, the person presses the push-button switch 22 to activate the activation-unit transmitter 18 to transmit communication waves as shown by waves 38 in FIG. 1. The transmitted waves 38 are received by the sign receiver/sign actuator unit 24. Then, the sign receiver/sign actuator unit 24 causes the display unit 28 to be illuminated. If desired, the display unit 28 can be illuminated in a flashing manner, to be more obviously attractive to emergency service workers.

With the embodiment of the invention shown in FIG. 2, the activation button unit 14 can be physically attached to the telephone 12 using an chemical adhesive material. If desired, a double-sided adhesive tape can be employed.

With the embodiment of the invention shown in FIG. 3, the first hook or loop material 30 is adhered to the telephone 12, and the second hook or loop material 32 is adhered to the activation button unit 14. Then, to attach the activation button unit 14 to the telephone 12, the second hook or loop material 32 is contacted with the first hook or loop material 30. If it desired to remove the activation button unit 14 from the telephone 12, the activation button unit 14 is simply pulled away from the telephone 12 to separate the second hook or loop material 32 from the first hook or loop material 30. The activation button unit 14 can then be attached to another telephone 12 which includes a quantity of first hook or loop material 30.

The communication waves can be any suitable waves. More specifically, the communication waves can be, for example, electromagnetic waves, such as radio waves. In this respect, the activation-unit transmitter 18 transmits radio waves, and the sign receiver/sign actuator unit 24 receives radio waves.

The components of the combination telephone, wireless activator, and sign apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved combination telephone, wireless activator, and sign apparatus that is low in cost, relatively simple in design and operation, and which may advantageously be used to provide a combination of an activation button unit for a remotely-located sign and a telephone. With the invention, a combination telephone, wireless activator, and sign apparatus provides for retrofitting a conventional telephone so that it is combined with an activation button unit for activating a remotely-located sign. With the invention, a combination telephone, wireless activator, and sign apparatus provides a physical connection between the activation button unit and the telephone which can be easily disconnected so that the activation button unit can be easily connected to another telephone. With the invention, a combination telephone, wireless activator, and sign apparatus provides both the activation button unit and the remotely-located sign with their own respective batteries. With the invention, a combination telephone, wireless activator, and sign apparatus is provided which can also be provided as an originally manufactured telephone which includes an activation button unit for activating a remotely-located sign.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. For example, if desired, the respective battery power sources used in the apparatus may optionally be supplanted suitably by hard-wired electrical power sources available at the location of the apparatus.

Hence, the proper scope of the present invention should be determined only by the broadest interpretation of the appended claims so as to encompass all such modifications as well as all relationships equivalent to those illustrated in the drawings and described in the specification.

What is claimed as being new and desired to be protected by Letters Patent of the United States is as follows:

1. A combination telephone, wireless activator, and sign apparatus, comprising:
a telephone which includes telephone-attached connecting means,
an activation button unit which includes button-unit-attached connecting means, wherein said button-unit-attached connecting means are physically attached to said telephone-attached connecting means, wherein said activation button unit includes an activation-unit transmitter, an activation-unit power source, and an activation-unit switch for connecting power from said activation-unit power source to said activation-unit transmitter, and
a remotely-located illuminated sign unit which includes a sign receiver/sign actuator unit, a sign power source, and a display unit powered by said sign power source when electrically connected to said sign power source by said sign receiver/sign actuator unit.

2. The apparatus of claim 1 wherein said activation-unit switch is a push-button switch.

3. The apparatus of claim 1 wherein said activation button unit and said remotely-located illuminated sign unit include indicia indicating “911”.

4. The apparatus of claim 1 wherein said telephone-attached connecting means and said button-unit-attached connecting means can be quantity of adhesive material located between said activation button unit and said remotely-located illuminated sign unit.

5. The apparatus of claim 1 wherein:
said telephone-attached connecting means includes a quantity of first hook or loop material, and
said button-unit-attached connecting means includes a quantity of second hook or loop material, and
said first hook or loop material and said second hook or loop material are complimentary and interconnectable.

6. The apparatus of claim 1 wherein said telephone and said activation button unit are combined as a unified, integrated, originally manufactured combination.

7. The apparatus of claim 1 wherein said power sources are battery power sources.
